(19) United States
(12) Patent Application Publication
(10) Pub. No.: US 2017/0002774 A1
(43) Pub. Date: Jan. 5, 2017

(54) Internal Combustion Engine Having Six Cylinders With Two of the Cylinders Being Dedicated EGR Cylinders Controlled With Dual EGR Valve

(71) Applicants: Martin Selway, Steyning (GB); Ian Paul Gilbert, Shoreham-by-Sea (GB); Marc C. Megel, La Vernia, TX (US)

(72) Inventors: Martin Selway, Steyning (GB); Ian Paul Gilbert, Shoreham-by-Sea (GB); Marc C. Megel, La Vernia, TX (US)

(73) Assignee: Southwest Research Institute, San Antonio, TX (US)

(21) Appl. No.: 14/755,058

(22) Filed: Jun. 30, 2015

(51) Int. Cl. F02M 26/41; F02M 26/70; F02M 26/53; F02M 26/55; F02M 26/16; F02M 26/42

(52) U.S. Cl. CPC F02M 26/41; F02M 26/16; F02M 26/42; F02M 26/53; F02M 26/55; F02M 26/70

(57) ABSTRACT

An exhaust gas recirculation (EGR) system for an internal combustion engine having two dedicated EGR cylinders. A dual valve system is used to control the output of the dedicated EGR cylinders so that the engine may intake EGR exhaust from both, only one, or neither of the dedicated EGR cylinders.

### TECHNICAL FIELD OF THE INVENTION

This invention relates to internal combustion engines, and more particularly to such engines having one or more cylinders dedicated to production of recirculated exhaust.

### BACKGROUND OF THE INVENTION

In an internal combustion engine system having dedicated EGR (exhaust gas recirculation), one or more cylinders of the engine are segregated and dedicated to operate in a rich combustion mode. As a result of the rich combustion, the exhaust gases from the dedicated cylinder(s) include increased levels of hydrogen and carbon monoxide. Rich combustion products such as these are often termed “syngas” or “reformate”.

Dedicated EGR engines use the reformate produced by the dedicated cylinder(s) in an exhaust gas recirculation (EGR) system. The hydrogen-rich reformate is ingested into the engine for subsequent combustion by the non-dedicated cylinders and optionally by the dedicated cylinder(s). The reformate is effective in increasing knock resistance and improving dilution tolerance and burn rate. This allows a higher compression ratio to be used with higher rates of EGR and reduced ignition energy, leading to higher efficiency and reduced fuel consumption.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a four cylinder engine with one dedicated EGR cylinder.

FIG. 2 illustrates a six cylinder engine with two dedicated EGR cylinders and a dual valve system in accordance with the invention.

FIG. 3 illustrates the dual valve system in further detail.

FIG. 4 illustrates the dual valve system set for a 33% EGR rate.

FIG. 5 illustrates the dual valve system set for a 17% EGR rate.

FIG. 6 illustrates the dual valve system set for a 0% EGR rate.

FIG. 7 illustrates how the dual valve system may be implemented with a single actuator for both valves.

### DETAILED DESCRIPTION OF THE INVENTION

The following description is directed to various systems and methods for a dedicated EGR system installed in a vehicle, such as an automobile, that also has an exhaust aftertreatment system. The dedicated EGR system of this invention has two dedicated EGR cylinders. A dual valve system controls the EGR exhaust flow so that the two dedicated EGR cylinders can be controlled to provide an EGR rate of 33%, 17% or 0% to the engine intake.

Conventional Dedicated EGR System (Prior Art)

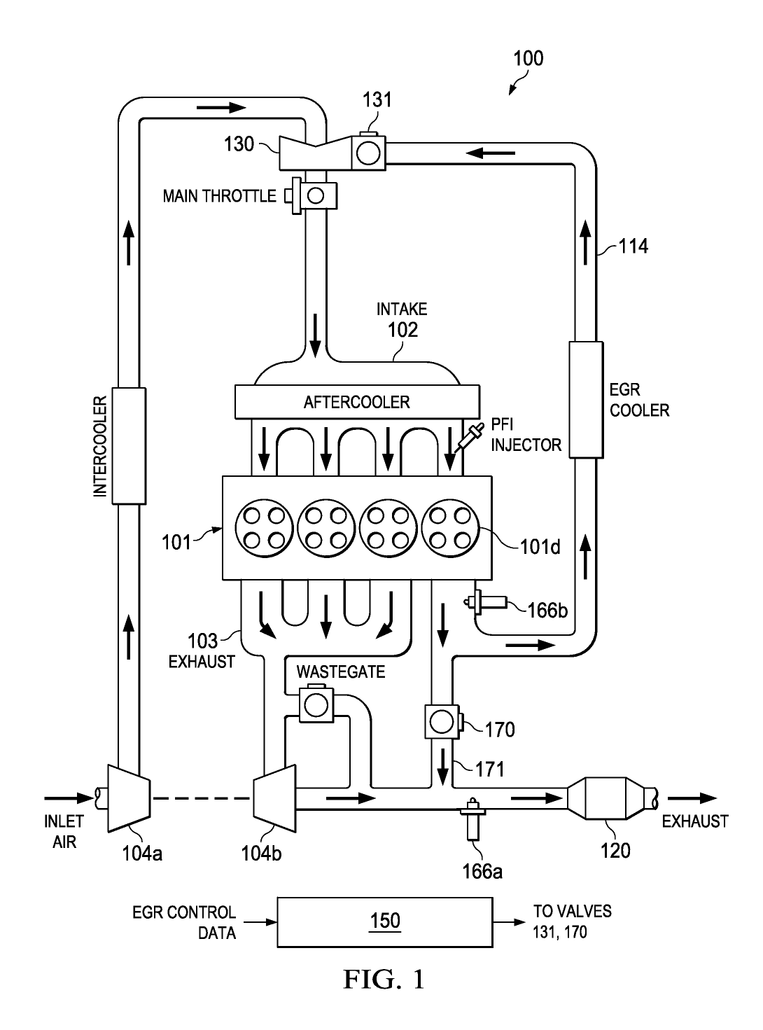

FIG. 1 illustrates an internal combustion engine 100 having four cylinders 101. One of the cylinders is a dedicated EGR cylinder, and is identified as cylinder 101d. In the example of FIG. 1, engine 100 is gasoline-fueled and spark-ignited, with each cylinder 101 having an associated spark plug.

The dedicated EGR cylinder 101d may be operated at any desired air-fuel ratio. All of its exhaust is recirculated back to the intake manifold 102.

In the embodiment of FIG. 1, the other three cylinders 101 (referred to herein as the “main” or “non dedicated” cylinders) are operated at a stoichiometric air-fuel ratio. Their exhaust is directed to an exhaust aftertreatment system via an exhaust manifold 103.

Engine 100 is equipped with a turbocharger, specifically a compressor 104a and a turbine 104b. Although not explicitly shown, the cylinders 101 have some sort of fuel delivery system for introducing fuel into the cylinders. This main fuel delivery system can be fumigated, port injected, or direct injected.

In the example of this description, the EGR loop 114 joins the intake line downstream the compressor 104a. A mixer 130 mixes the fresh air intake with the EGR gas. A throttle 105 is used to control the amount of intake (fresh air and EGR) into the intake manifold 102.

An EGR valve 131 may be used to control the EGR intake into the intake manifold 102. Alternatively, other means, such as variable valve timing, may be used to control EGR flow.

In other dedicated EGR systems, there may be a different number of engine cylinders 101, and/or there may be more than one dedicated EGR cylinder 101d. In general, in a dedicated EGR engine configuration, the exhaust of a sub-group of cylinders can be routed back to the intake of all the cylinders, thereby providing EGR for all cylinders. In some embodiments, the EGR may be routed to only the main cylinders.

After entering the cylinders 101, the fresh-air/EGR mixture is ignited and combusts. After combustion, exhaust gas from each cylinder 101 flows through its exhaust port and into exhaust manifold 103. From the exhaust manifold 103, exhaust gas then flows through turbine 104b, which drives compressor 104a. After turbine 104b, exhaust gas flows out to a main exhaust line 119 to a three-way catalyst 120, to be treated before exiting to the atmosphere.

As stated above, the dedicated EGR cylinder 101d can operate at any equivalence ratio because its exhaust will not exit the engine before passing through a non-dedicated EGR cylinder 101 operating at a stoichiometric air-fuel ratio. Because only stoichiometric exhaust leaves the engine, the exhaust aftertreatment device 120 may be a three-way catalyst.

To control the air-fuel ratio, exhaust gas may be sampled by an exhaust gas oxygen (EGO) sensor. Both the main exhaust line 122 and the EGR loop 114 may have a sensor (identified as 166a and 166b), particularly because the dedicated EGR cylinder may be operated at a different air-fuel ratio than non-dedicated cylinders.

If a dedicated EGR cylinder is run rich of stoichiometric A/F ratio, a significant amount of hydrogen (H2) and carbon monoxide (CO) may be formed. In many engine control strategies, this enhanced EGR is used to increase EGR tolerance by increasing burn rates, increasing the dilution limits of the mixture and reducing quench distances. In addition, the engine may perform better at knock limited conditions, such as improving low speed peak torque results, due to increased EGR tolerance and the knock resistance provided by hydrogen (H2) and carbon monoxide (CO).

The four-cylinder dedicated EGR system 100 works well with a single dedicated cylinder, giving a 25% EGR rate. For engine start and low load/temperature operation, a bypass valve 170 and bypass line 171 may be used to reduce the EGR rate. If EGR exhaust gas is bypassed to the main exhaust line instead of to the EGR loop, the dedicated EGR cylinder may be made to run stoichiometric during the bypass period, so that the three-way catalyst aftertreatment system will remain effective.

An EGR control unit 150 has appropriate hardware (processing and memory devices) and programming for controlling the EGR system. It receives data from the sensors described above, and performs various EGR control algorithms. It then generates control signals to the various valves and other actuators of the EGR system.

Dedicated EGR System with Four Main Cylinders, Two Dedicated EGR Cylinders, and Dual EGR Valve System

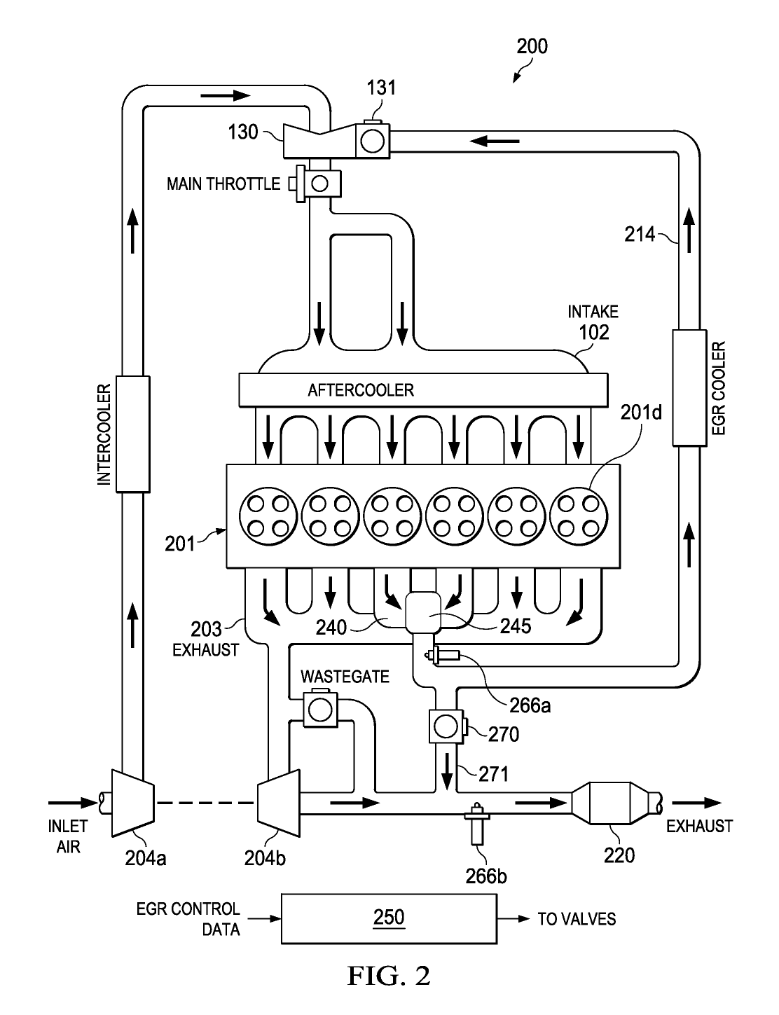

FIG. 2 illustrates an EGR system 200 configured with a total of six cylinders 201. Four of the cylinders are main cylinders 201; two of the cylinders are dedicated EGR cylinders 201d. The dedicated EGR cylinders 201d are the middle two cylinders of an in-line cylinder layout. For purposes of identification herein, the main cylinders 201 may be referred to as Cylinders 1, 2, 5 and 6. The dedicated EGR cylinders 201d may be referred to as Cylinders 3 and 4.

Although details are not explicitly shown in FIG. 2, and are more fully described below, EGR system 200 also has a dual valve system 245 that allows adjustment of the EGR rate. This dual valve system 245 switches the EGR flow from 2, 1 or 0 paths into the EGR loop. The dual valve system 245 receives EGR exhaust from a short exhaust manifold 240 that has two separate ports into the EGR valve system 245, one for each dedicated EGR cylinder 201d. The dual valve system 245 delivers EGR exhaust to either the main exhaust line (via bypass line 270) or to the EGR loop 214.

Other than having two dedicated EGR cylinders 201d rather than one, and having dual valve system 245, engine 200 has the same basic elements as, and operates similarly to, the four-cylinder engine described above.

As stated above, a four-cylinder engine with one dedicated EGR cylinder allows a 25% EGR rate. For engines with different numbers of cylinders, different rates of EGR are possible. For example, a six-cylinder engine with one dedicated EGR cylinder can have a 17% EGR rate, and with two dedicated EGR cylinders it can have a 33% EGR rate. However, it has been shown that 17% EGR may not give the same benefits as 25% EGR. On the other hand, 33% EGR may be too high to sustain reliable combustion at certain operating conditions, such as at light loads and low speeds. It would therefore be beneficial to be able to switch between different EGR rates during engine operation.

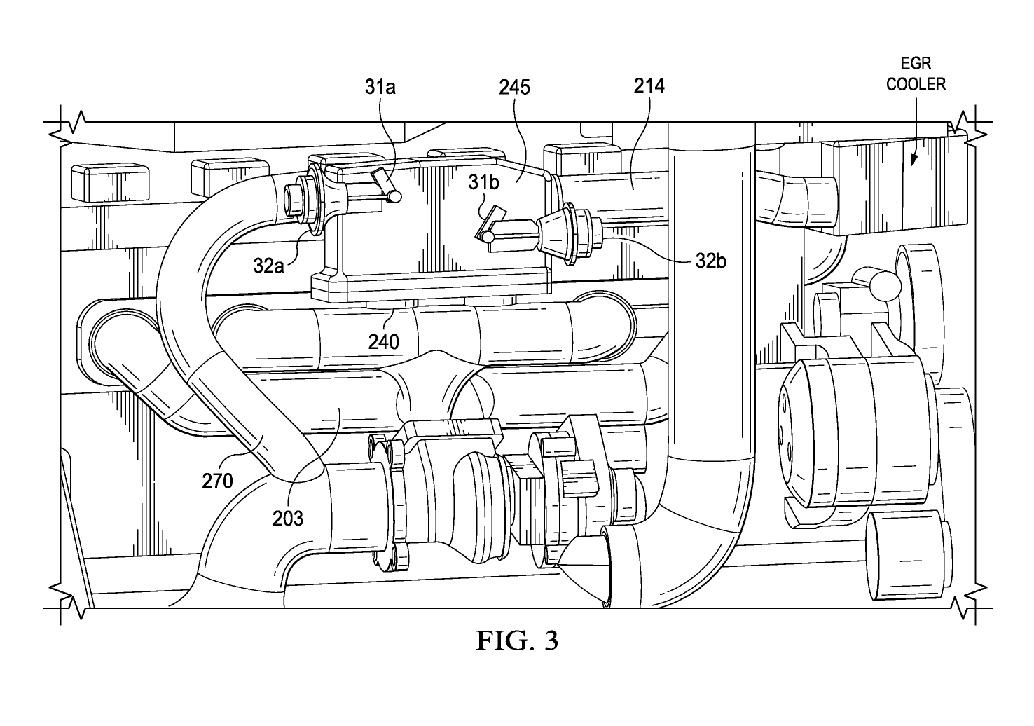

FIG. 3 illustrates dual valve system 245 in further detail, as well as its connections to other engine components, its location, and its relative size in the engine bay. In the embodiment of FIG. 3, dual valve system 245 is housed in a small housing, which contains valves 31a and 31b.

As explained below, each valve 31a and 31b is associated with exhaust input from one of the dedicated EGR cylinders 210d. Specifically, valve 31a is associated with dedicated EGR Cylinder 4 and valve 31b is associated with dedicated EGR Cylinder 3.

From valve system 245, EGR may exit into EGR loop 214 or into the main exhaust line 219. In the example of this description, where the EGR system has a by-pass line 270, the connection to the main exhaust line is via this by-pass line 270.

As discussed in further detail below, each valve 31a and 31b has an associated actuator 32a and 32b. In the embodiment described herein, each valve is a “flap” type valve. The flap pivots to close one output opening and open the other. Thus, the actuation for each valve is two-position, that is, either open or closed. Each valve selects one of two possible paths for EGR exhaust flow.

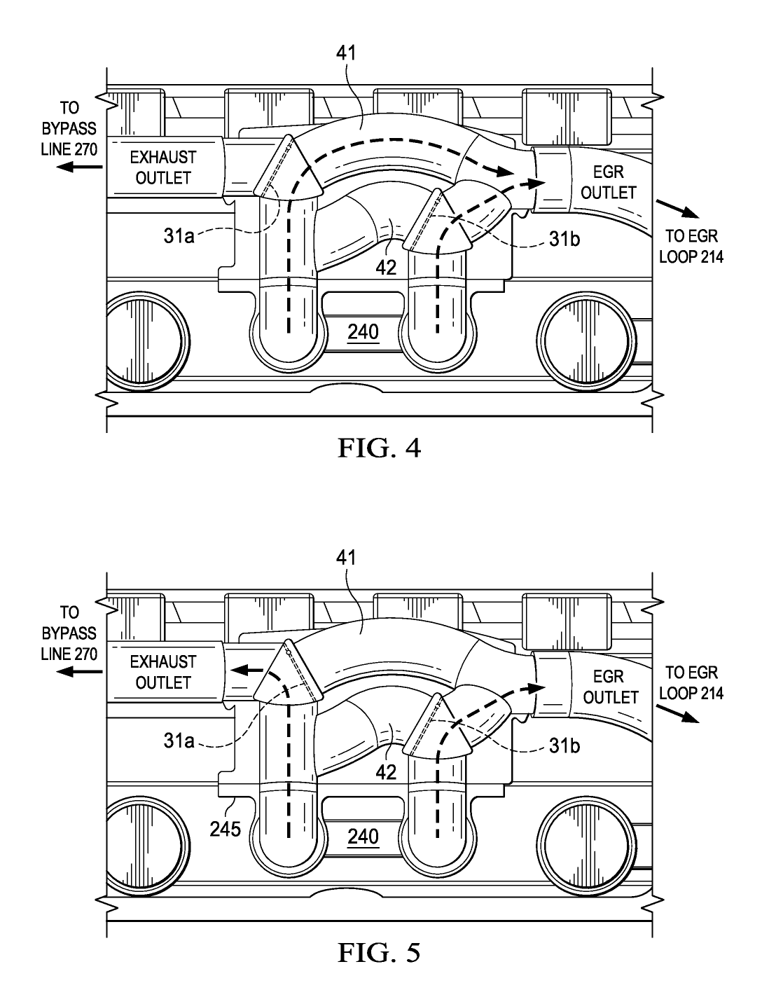

FIGS. 4-6 are cross sectional views of valve system 245. These figures show valves 31a and 31b in three possible operating states.

As illustrated, EGR manifold 240 (or other output structure from the dedicated EGR cylinders) provides separate inputs for each dedicated EGR cylinder 201d into valve system 245. Thus, the housing for valve system 245 has two EGR input ports.

Each EGR input goes to a valve 31a or 31b via an EGR input connection line 43 or 44, respectively. Depending on the positions of the valves, internal cross-flow lines 41 and 42 are used to direct EGR flow from each dedicated EGR cylinder (Cylinders 3 and 4) to either the EGR loop 214 or to bypass line 270.

Valves 31a and 31b are each single-input/dual-output valves. Hence, they are a type of three-way valve, but more specifically, are used to select fluid flow from a single input to one of two outputs. Thus, valves 245a and 245b may be more specifically referred to as “selector” or “two-position” three-way valves.

As stated above, valves 31a and 31b operate by opening and closing flaps, which either allow or block fluid flow. Other three-way valve mechanisms, known in the art of fluid flow valves, are possible. Examples are rotary and spool valves.

An example of an actuator 32a or 32b for this type of valve is a vacuum actuator. The vacuum source could be the intake manifold depression or an electrically or mechanically driven vacuum pump. In many automotive systems, a vacuum source is already available for providing assistance to the vehicle brakes or for powering other vacuum actuators. Electrically driven solenoid valves are used to control the flow of vacuum from the vacuum source to the vacuum actuator. In other embodiments, various electric actuators could be used. Furthermore, as explained below in connection with FIG. 7, in other embodiments, actuators 32a and 32b could be replaced with a single actuator that drives both valves 31a and 31b.

FIG. 4 illustrates valve system 245 set to route EGR exhaust from both dedicated EGR cylinders 201d (Cylinders 3 and 4) into the EGR loop 214. This results in an EGR rate of 33% (33⅓% rounded). The flaps of both valves 31a and 31b are set to the left, such that exhaust from each dedicated EGR cylinder is presented with a relatively unrestricted route through valve system 245. This results in a minimum of pressure loss.

FIG. 5 illustrates valve system 245 set to route EGR exhaust gas from Cylinder 3 to EGR loop 214 and EGR exhaust gas from Cylinder 4 to the main exhaust line (via by-pass line 270). This results in an EGR rate of 17% (16⅔% rounded). The flap of valve 31a is set to the right, and the flap of valve 31b is set to the left. The gas flow from each dedicated EGR cylinder 201d is still presented with a relatively unrestricted path.

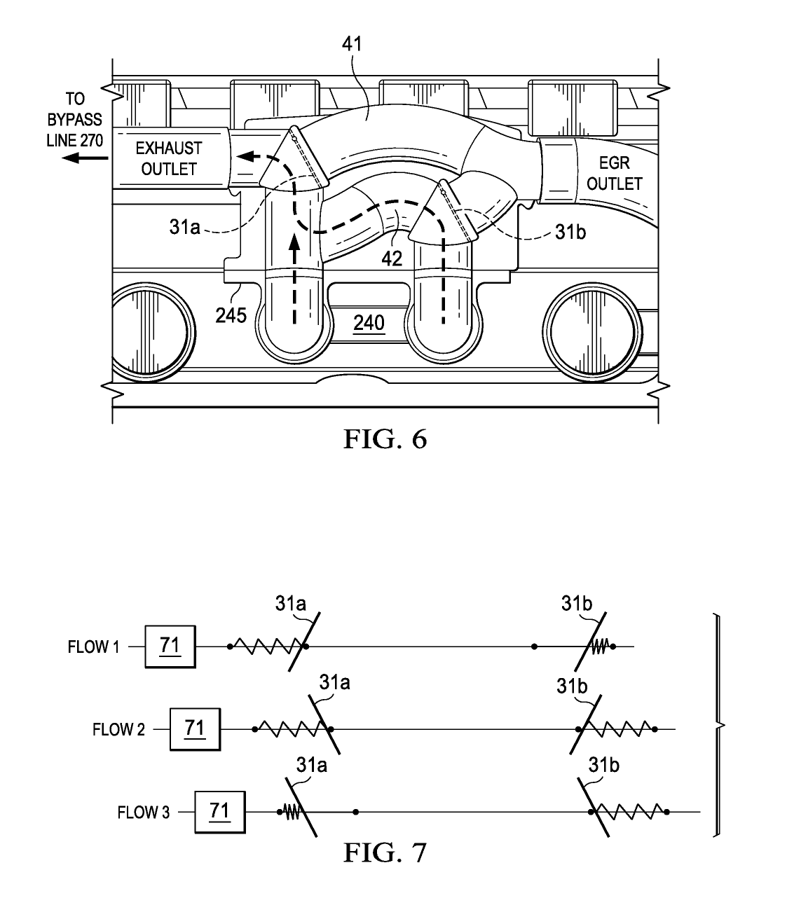

FIG. 6 illustrates valve 245 system set to route all EGR exhaust gas to the main exhaust line (via by-pass line 270), resulting in 0% EGR. Both valve flaps are set to the right. Although the flow path from Cylinder 3 is somewhat tortuous, a 0% EGR state is only used in very low load conditions when the gas flowrate is small. Thus, any flow restriction caused by the flow path would be minimal.

Valve system 245 may be easily implemented as an integrated cast component. This cast component would contain cross-over lines 41 and 42, and EGR input lines 43 and 44. Valves 31a and 31b and their actuators may be contained in or connected to the cast component at or near ports. The cast component would have two input ports for EGR, an output port to the main exhaust line, and an output port to the EGR loop.

An advantage of the dual valve system 245, particularly as a cast component, is that it is compact. In an engine bay, available space is usually already at a premium. It is therefore beneficial to minimize the size of any additional equipment.

Referring again to FIG. 2, EGR control unit 250 has appropriate hardware and programming for implementing the above-described EGR rate control. Control unit 250 receives input data, such as data representing engine load and cold start conditions. It uses this input data to determine the desired EGR rate for the current engine operating conditions. Based on this determination, it generates control signals for actuators 32a and 32b.

FIG. 7 illustrates how the valves 31a and 31b may be driven with a single three-position actuator 71. The valve system 245 is the same as that described above. However, valves 31a and 31b are simultaneously actuated by a single actuator 71, which connects the valves with a linkage mechanism. Actuator 71 may have a spring-loaded “lost motion” mechanism, and the springs sized to prevent valve opening at undesired times due to gas pressure. The valves 31a and 31b are opened or closed as described above to achieve the flow paths for a 33%, 17% or 0% EGR rate.

What is claimed is:

1. A valve system for an internal combustion engine having two dedicated EGR cylinders, one dedicated EGR cylinder exhausting EGR exhaust to a first EGR outlet and the other dedicated EGR cylinder exhausting EGR exhaust to a second EGR outlet, and the engine having an EGR loop and a main exhaust line, the valve system comprising:
a first input line providing fluid flow communication from the first EGR outlet to the main exhaust line;
a second input line providing a fluid flow communication from the second EGR outlet to the EGR loop;
a first cross-over line providing a fluid flow communication from the first input line to the second input line;
a first valve located upstream a connection of the first input line and the first cross-over line and at a connection of the first input line to the main exhaust line;
a second cross-over line providing fluid flow communication from the first valve to the EGR loop;
a second valve on the second input line, located at a connection between the first cross-over line and the second input line;
wherein the first valve is operable to direct EGR exhaust from the first input line to either the main exhaust line or to the second cross-over line; and
wherein the second valve is operable to direct EGR exhaust from the second input line to either the first cross-over line or to the EGR loop.

2. The valve system of claim 1, wherein EGR loop has a bypass line to the main exhaust line and the connection of the first input line to the main exhaust line is via by-pass line.

3. The valve system of claim 1, wherein the first valve and the second valve have separate actuators.

4. The valve system of claim 1, wherein the first valve and the second valve are driven by the same actuator.

5. The valve system of claim 1, wherein the first valve and the second valve are vacuum-actuated valves.

6. The valve system of claim 1, wherein the engine is installed in an automotive vehicle, and the first valve and the second valve are driven by a vacuum actuator that drives other mechanisms of the vehicle.

7. The valve system of claim 1, wherein the first valve and the second valve are flap-type valves.

8. The valve system of claim 1, wherein the first valve and the second valve are driven by an electronic actuator.

9. The valve system of claim 1, wherein the first valve and the second valve are rotary or spool valves.

10. The valve system of claim 1, wherein the first input line, second input line, first cross-over line, and second cross-over line are formed as a cast component.

11. A method of using an exhaust gas recirculation (EGR) system for an internal combustion engine, the engine having two dedicated EGR cylinders, one dedicated EGR cylinder exhausting EGR exhaust to a first EGR outlet and the other dedicated EGR cylinder exhausting EGR exhaust to a second EGR outlet, and the engine having an EGR loop and a main exhaust line, the method comprising:
receiving EGR exhaust from a first dedicated EGR cylinder into a first valve input line;
receiving EGR exhaust from a second dedicated EGR cylinder into a second valve input line;
connecting the first valve input line to the second valve input line via a first cross-over line;
connecting the first valve input line to the EGR loop via a second cross-over line;
wherein the connection of the first valve input line to the second cross-over line is a first three-way connection also to the main exhaust line;
wherein the connection of the second valve input line to the first cross-over line is a second three-way connection also to the EGR loop;
operating valves at the first three-way connection and the second three-way connection such that EGR exhaust from both cylinders flows into the EGR loop, or EGR exhaust from only one cylinder flows into the EGR loop, or no EGR exhaust flows into the EGR loop, and such that exhaust not flowing into the EGR loop flows into the main exhaust line.

12. The method of claim 11, wherein EGR loop has a bypass line to the main exhaust line and the connection of the first input line to the main exhaust line is via by-pass line.

13. The method of claim 11, wherein the valves are driven by separate actuators.

14. The method of claim 11, wherein the valves are driven by the same actuator.

15. The method of claim 11, wherein the valves are vacuum-actuated valves.

16. The method of claim 11, wherein the engine is installed in an automotive vehicle, and the valves are driven by a vacuum actuator that drives other mechanisms of the vehicle.

17. The method of claim 11, wherein the valves are flap-type valves.

18. The method of claim 11, wherein the valves are driven by an electronic actuator.

19. The method of claim 11, wherein the valves are rotary or spool valves.
